(19) United States
(12) Patent Application Publication
(10) Pub. No.: US 2008/0319780 A1
(43) Pub. Date: Dec. 25, 2008

(54) Defining reports for dimension based enterprise resource planning systems

(75) Inventors: John C. Hellyer, Denver, CO (US); Mike R. Evans, Castle Rock, CO (US); Eric C. Peterson, Parker, CO (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/823,115

(22) Filed: Jun. 25, 2007

(51) Int. Cl. G06Q 10/00

(52) U.S. Cl. 705/1

(57) ABSTRACT

A reporting tool is used to create reports for dimension based ERP (“Enterprise Resource Planning”) systems. The dimensions for the report may be selected manually and/or automatically. The reports are defined using the selected dimensions that are obtained directly from the ERP system without including the fully qualified account information. Additionally, dimension hierarchies may be imported directly from the ERP system.

### BACKGROUND

Today's business landscape is extremely competitive and results-driven. More than ever before, executives depend on current, accurate reports to understand business performance and to meet regulatory requirements. Producing accurate and updated reports on an ongoing basis, however, places a burden on financial officers and accountants.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A reporting tool is used to create reports for dimension based ERP (“Enterprise Resource Planning”) systems. The dimensions for the report may be selected manually and/or automatically generated. The reports are defined using the selected dimensions that are obtained directly from the ERP system. The specified dimensions are defined within the report definition without referencing the dimensions that are not included within the report.

### BRIEF DESCRIPTION OF THE DRAWINGS

FIG. 1 illustrates an exemplary computing device;

FIG. 2 shows a block diagram of a report defining system;

FIG. 3 illustrates using a row format to select dimensions to include in a report definition;

FIG. 4 shows selecting a set that is defined in the ERP system;

FIG. 5 illustrates a resulting sample row definition;

FIG. 6 shows automatically building row formats based on automatic member retrieval;

FIG. 7 illustrates an exemplary auto-built row format;

FIG. 8 shows using a column layout to refine the report definition;

FIG. 9 shows using the interface to build a tree format to refine the report definition;

FIG. 10 illustrates inserting reporting units from chart of accounts/dimensions;

FIG. 11 shows dynamically splitting segments; and

FIG. 12 shows an illustrative process for creating a report definition for an ERP system.

### DETAILED DESCRIPTION

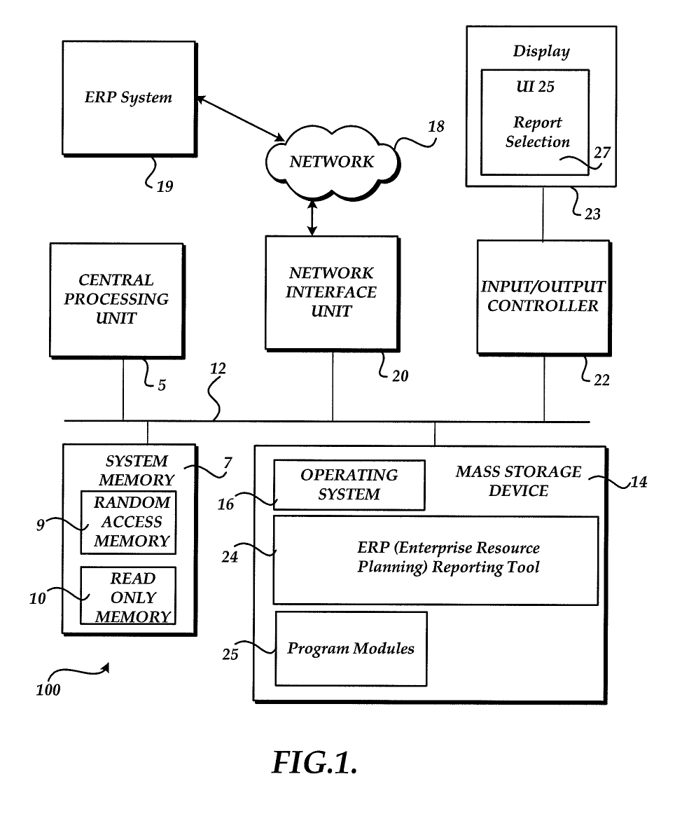

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, a report selection user interface 27, an ERP system 19, an ERP reporting tool 24, and other program modules 25, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 23, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS® VISTA® operating system from MICROSOFT® CORPORATION of Redmond, Wash. The mass storage device 14 and RAM 9 may also store one or more program modules. In particular, the mass storage device 14 and the RAM 9 may store one or more application programs, such as an ERP (“Enterprise Resource Planning”) reporting tool 24. According to one embodiment, the ERP reporting tool 24 defines reports for a dimension based ERP system 19. The ERP reporting tool 24 includes a report selection user interface 27 for selecting dimensions from ERP system 19 to include within a report definition. The dimensions to be included in the report definition may be selected manually and/or automatically generated and then included in the report definition. The selected dimensions are combined to define the report and are specified as incomplete dimension structures. In other words, the dimensions not included within the report are not specified within the report definition. In this way, reports do not need to be re-factored when a dimension is added or deleted within the ERP system. Additionally, dimension hierarchies may be imported directly from the ERP system such that dimensions may be manually and/or automatically selected to be included within the report definition. Additional details regarding defining reports for dimension based ERP systems will be provided below.

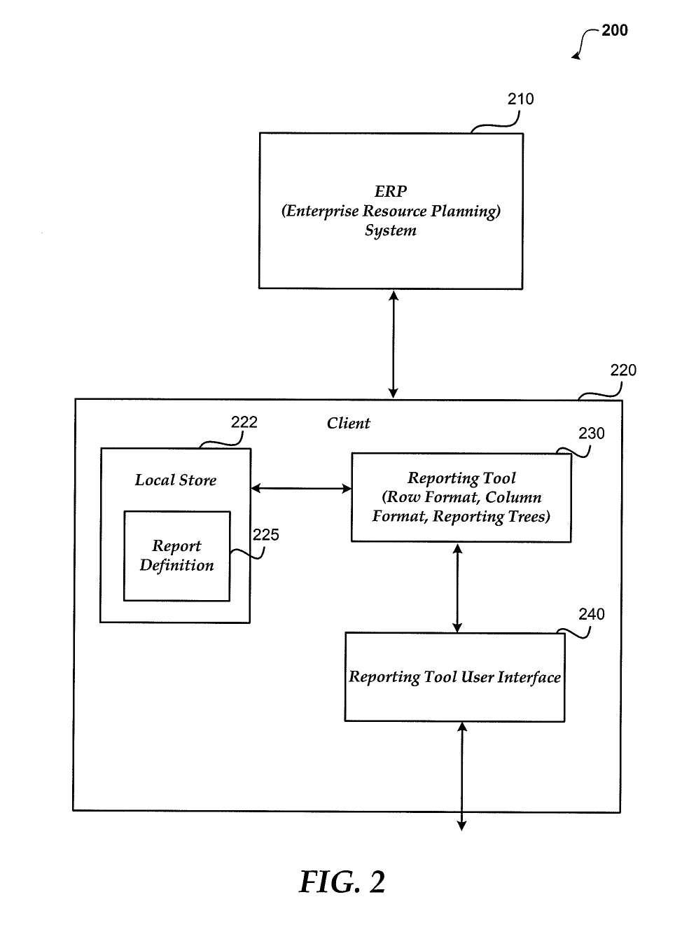

FIG. 2 illustrates a system for defining reports for a dimension based ERP system. The system includes a dimension based ERP system 210 coupled to client 220. ERP system 210 may access many different servers and back end data stores to retrieve data that is associated with ERP system 210. Client 220 includes local store 222, reporting tool 230 and reporting tool user interface 240.

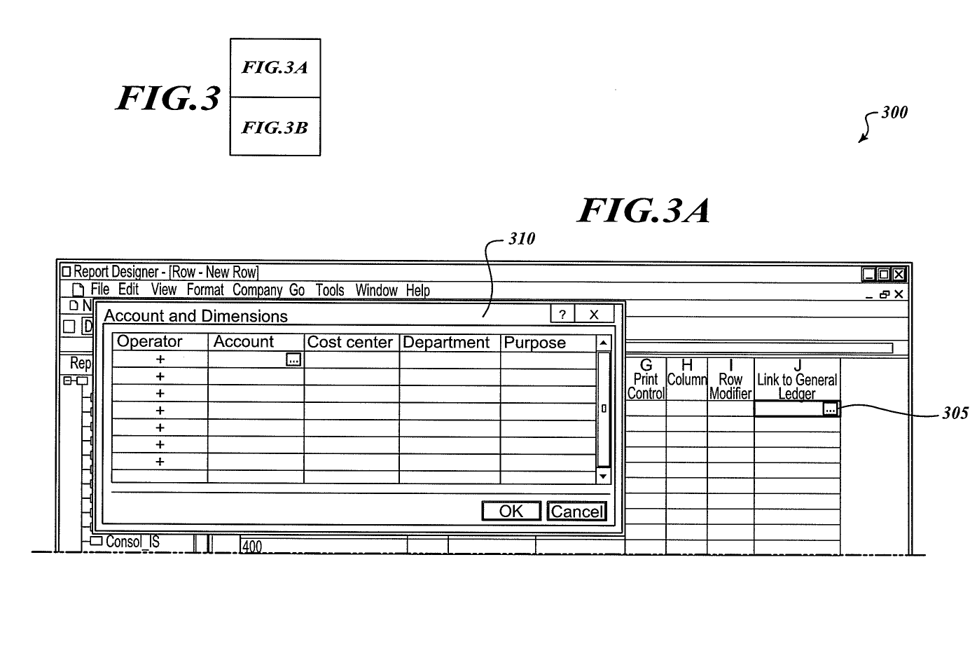

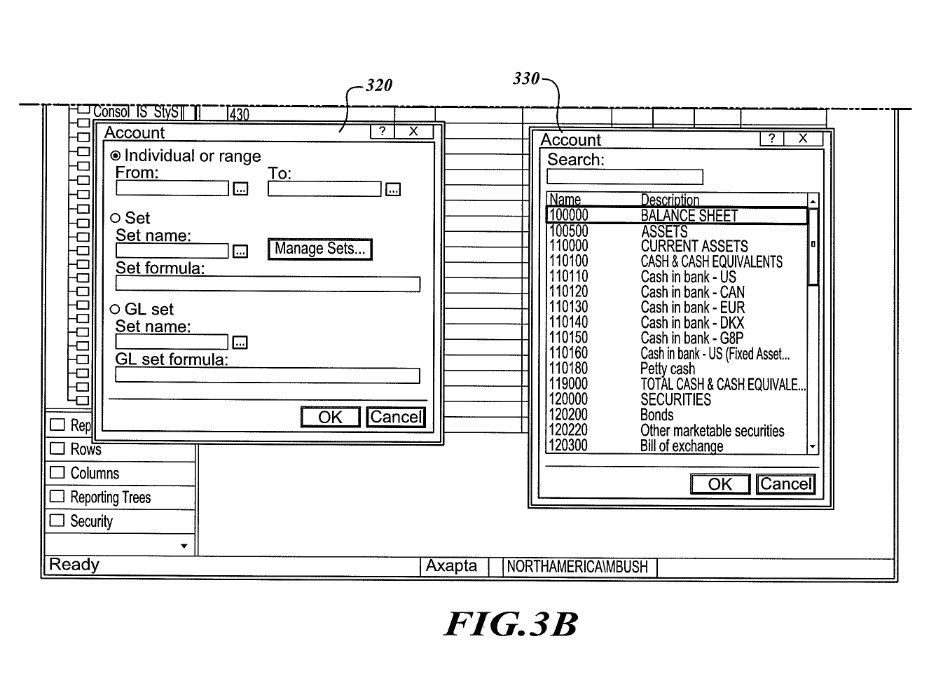

Generally, defining a report involves selecting the dimensions from ERP system 210 to be included within the report. According to one embodiment, the dimensions are dynamically obtained from ERP system 210. Alternatively, the dimensions may be stored within a data store, such as local store 222 or in some other combination. Local store 222 may also be used to store report definition 225. Reporting tool user interface 240 is used to select dimensions to be included within a report definition (For an exemplary user interface for selecting dimensions see FIGS. 3-11 and related discussion).

According to one embodiment, three basic building blocks are used by the reporting tool 230 to create report definitions including, row format, column format, and reporting trees. Using these building blocks, any combination of dimensions can be included within a report. Reporting tool 230 is configured to build a report definition in response to the selections received through reporting tool user interface 240. Interface 240 includes options to indicate which dimensions to use in the report definition. For example, the user can select a single dimension, a range of dimensions, or a set of dimensions. Any combination of dimensions may be utilized to define the report. The reporting tool user interface 240 may also be utilized to specify dimensions that are used to automatically build a report definition. As discussed above, the definitions specified within the report include only the specified dimension combinations without including the fully qualified account structure. Since the report definition does not include the full account structure every report does not need to be re-factored to include newly added dimensions. Examples are provided in FIGS. 3-11 to clarify the selection of dimensions to include within a report definition.

FIG. 3 illustrates using a row format to select dimensions to include in a report definition.

Using the row format a user may select individual accounts, a range of accounts, and/or a list of noncontiguous accounts to be included in a report. In the present example, the user indicates they want real time dimension access to the dimensions within the ERP system by selecting box 305 under the ledger column. Window 310 lists the dimensions that are available to be included within a report (i.e. account, cost center, department, and purpose). The dimensions illustrated are for explanation purposes only and are intended to be non-limiting. Other dimensions would be available in other ERP systems. The user then selects from the available dimensions which dimension they want to include in the report definition. Window 320 allows a user to select a single dimension member, a range of dimension members or a set defined within the ERP system for the selected dimension. If the user chooses an individual or range, a list of individual dimension members is displayed to the user to pick from in window 330. According to one embodiment, the list includes the name and a user friendly description. This process may be repeated to add other available dimensions. For example, a user may select purpose within window 310.

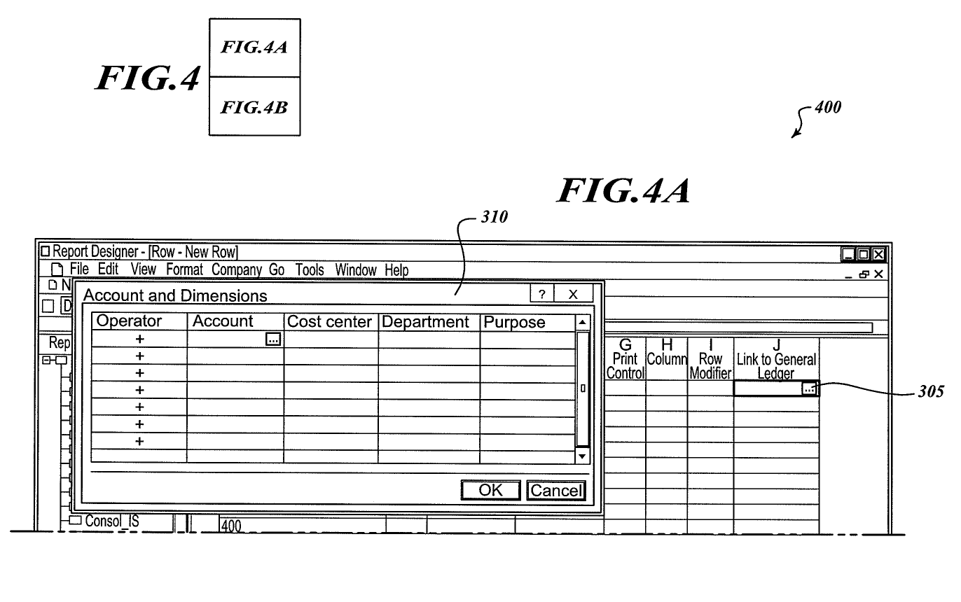

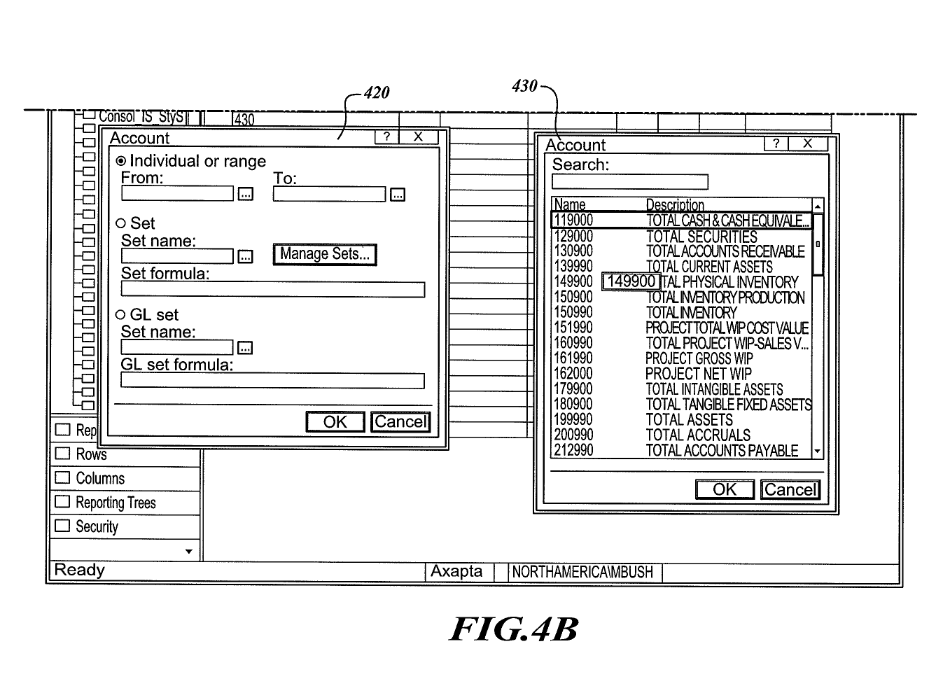

FIG. 4 shows selecting a set of dimensions that is defined in the ERP system. FIG. 4 is similar to FIG. 3 but illustrates the user selecting a set of dimensions using window 420. When the user chooses a set of dimensions to be defined, a list of the sets that are available from the ERP system is displayed for the user to pick from within window 430.

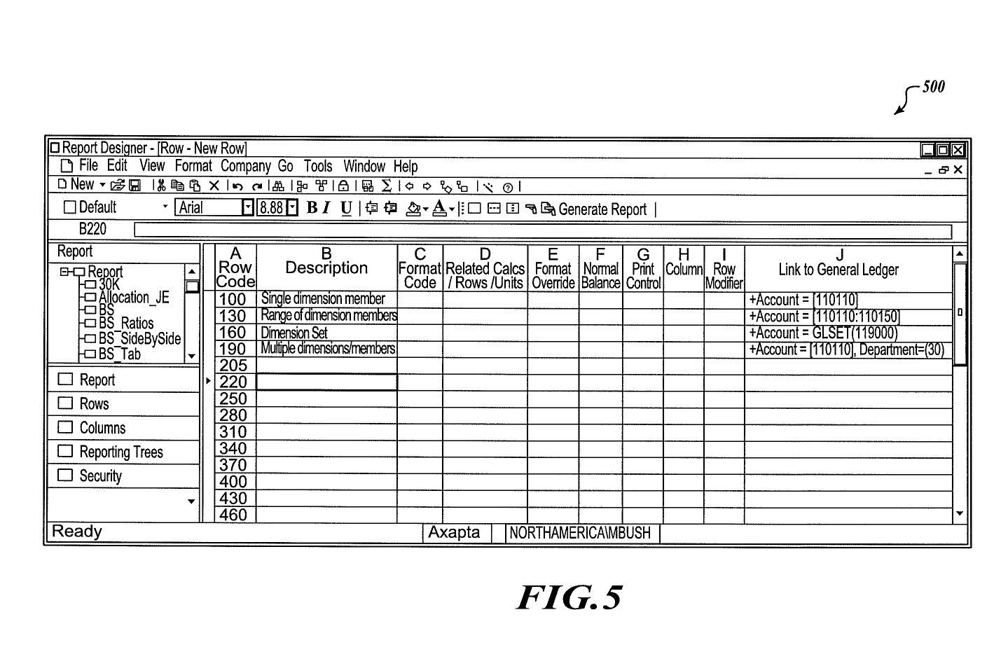

FIG. 5 illustrates a resulting sample row definition. As can be seen, Row Code 100 includes a single dimension member that is listed under the Link to General Ledger column. In the present example, the account is listed as 110110. Row code 130 includes a range of dimension members (110110 through 110150) under the General Ledger column. Row code 160 is a dimension set defined as GLSET(119000) under the General Ledger column. Row code 190 includes multiple dimensions/members under the General Ledger column including an account 110110 and department 30. As can be seen, a definition may contain many different dimensions/members. Additionally, referring to the Link to General Ledger column, it can be seen that the row definition includes the specified dimensions without including all of the other available dimensions. For instance, row code 100 specifies a single account without including a department and row code 190 specifies a single account and a department.

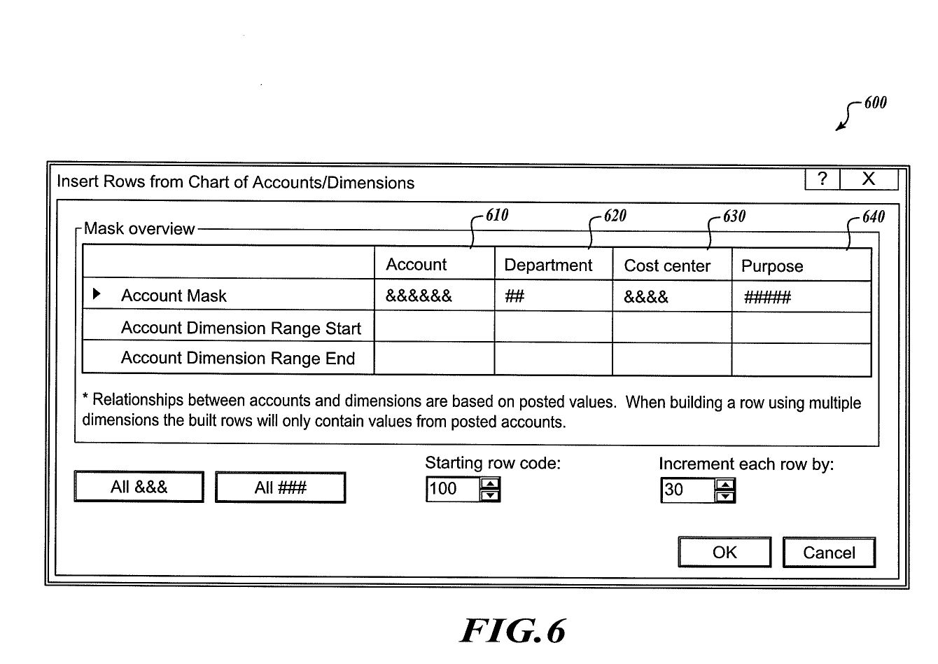

FIG. 6 shows automatically building row formats based on automatic member retrieval. The user can select a dimension or a combination of dimensions with which they want to automatically build a row definition. As discussed previously, a fully qualified account specification is not needed to define the dimension or combination of dimensions within a report definition. As illustrated in screen 600, the ampersands “&” indicate to the reporting tool to include these dimensions when the definition is automatically built. The number signs “#” indicate to the reporting tool that the dimension is to be ignored. Screen 600 shows four dimensions including account dimension 610, department dimension 620, cost center 630 and purpose dimension 640. As discussed above, the screens illustrated and discussed are for explanation purposes only and are not intended to be limiting. Other ERP systems would show different dimensions. In screen 600, the user has indicated to auto build a row format based on the account 610 and cost center dimensions 630. The user has indicated to ignore the department 620 and purpose 640 dimensions. Alternatively, the user may have specified any other combination as desired.

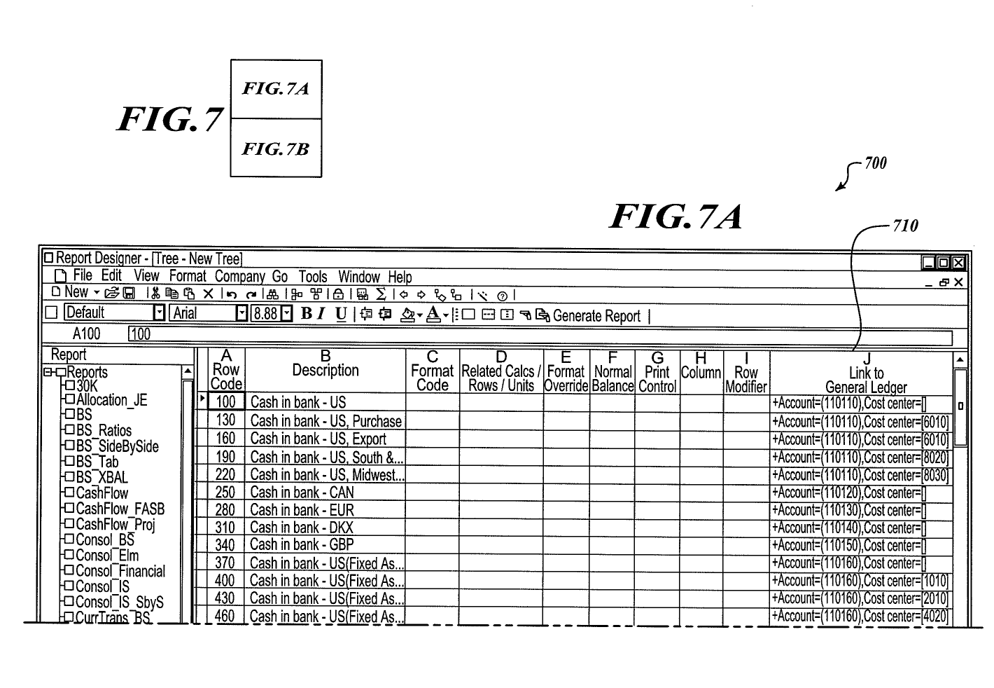

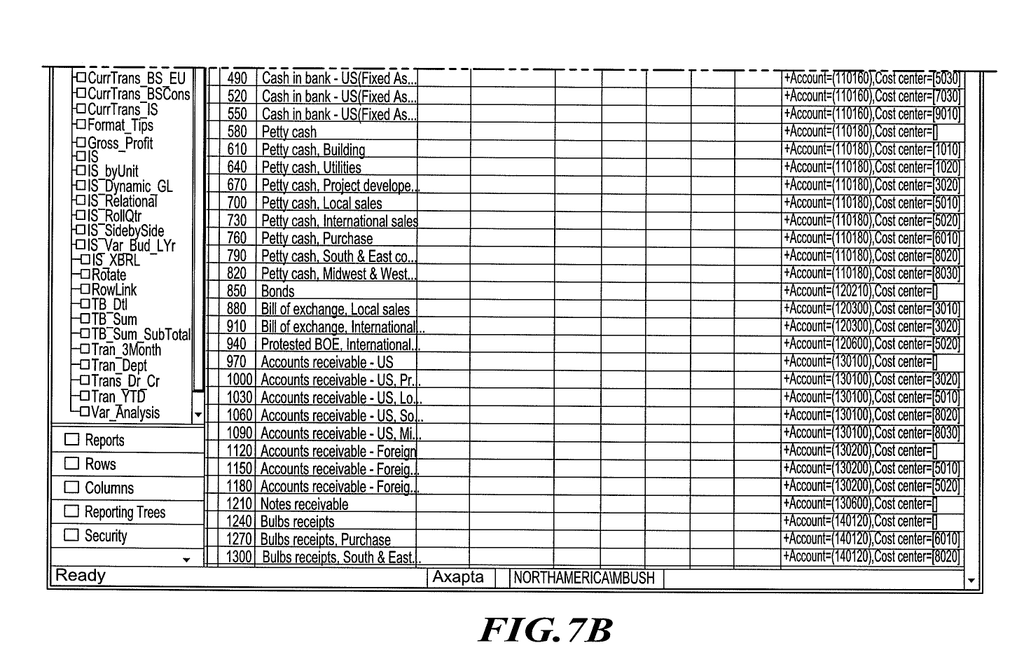

FIG. 7 illustrates an exemplary auto-built row format. Referring to the “Links to General Ledger” column 710 within screen 700 it can be seen that general ledger includes only the specified dimension combinations the user wanted (account and cost center) and does not include a fully qualified account definition. This is in contrast to prior art systems which include a fully qualified account definition. Not including the fully qualified account makes it easier to add dimensions to existing ERP systems without “breaking” existing reports. Additionally, reports do not need to be re-factored when a dimension is added or deleted. According to one embodiment, the description column illustrated in screen 700 is automatically filled in with the description information that corresponds to the dimensions that are generated during the auto build.

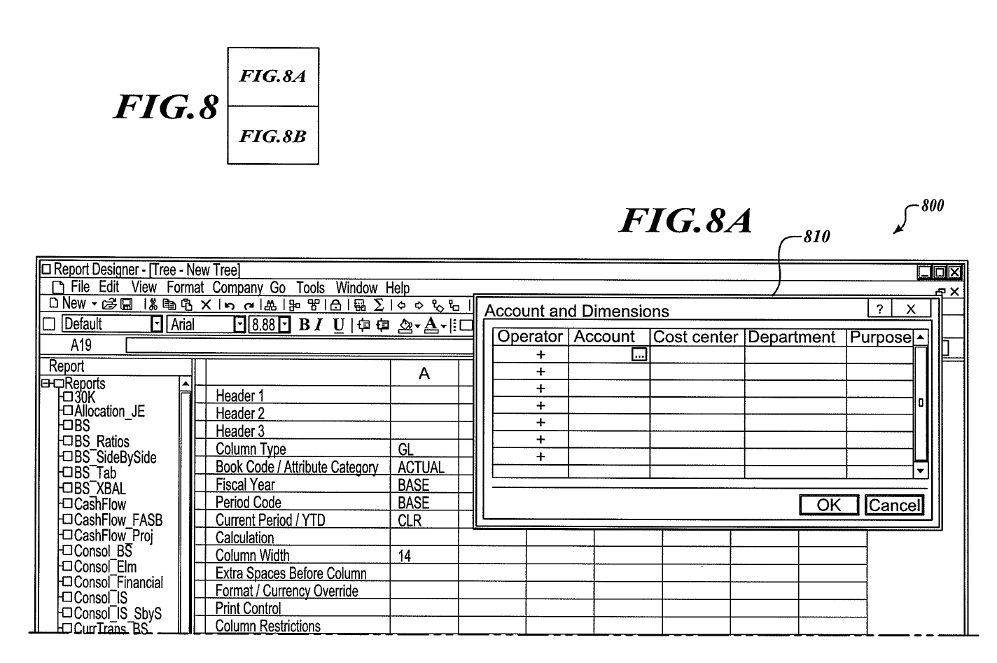

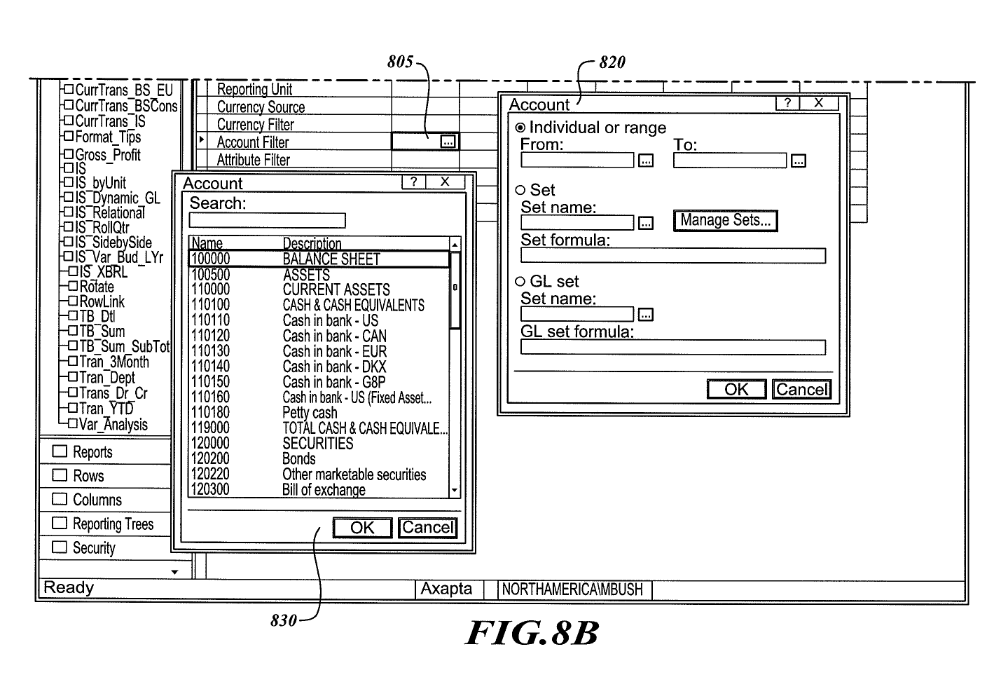

FIG. 8 shows using a column layout to refine the report definition. The column layout interface 800 allows the user to define dimension filters in much the same way as in the row format. After selecting account filter box 805, window 810 lists the dimensions that are available to be included within the report definition. The user then selects which dimension they want to use within the report definition. In the present example, the user has selected the account dimension within window 810. In response to the dimension being selected, window 820 is displayed allowing the user to define if they want to use a single dimension member, a range of dimension members or a set defined in the ERP system. If the user chooses an individual or range, a list of dimension members is displayed within window 830 to the user to pick from. If the user chooses a set the list of sets is presented to the user.

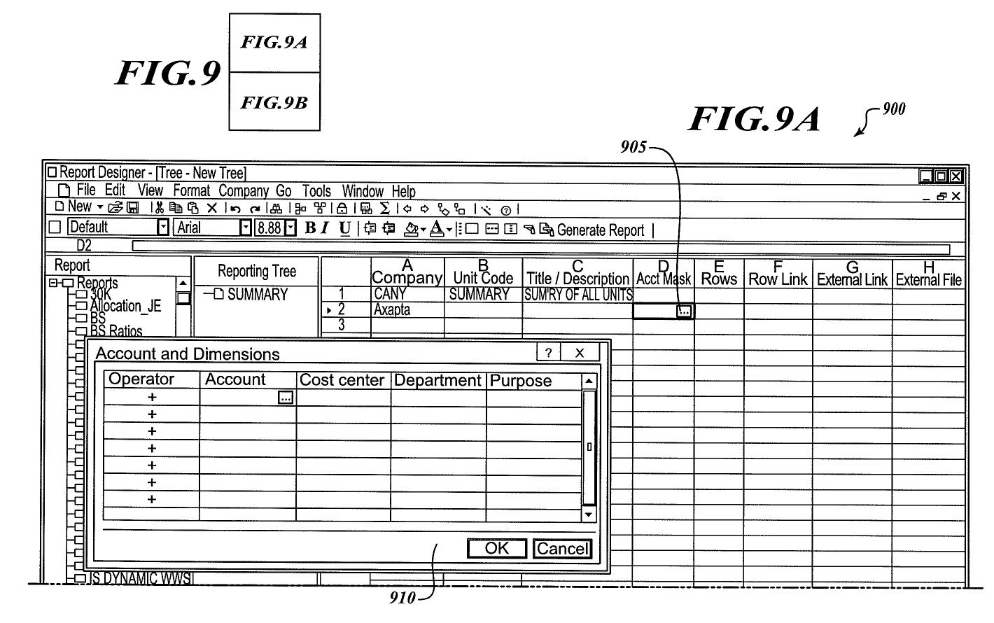

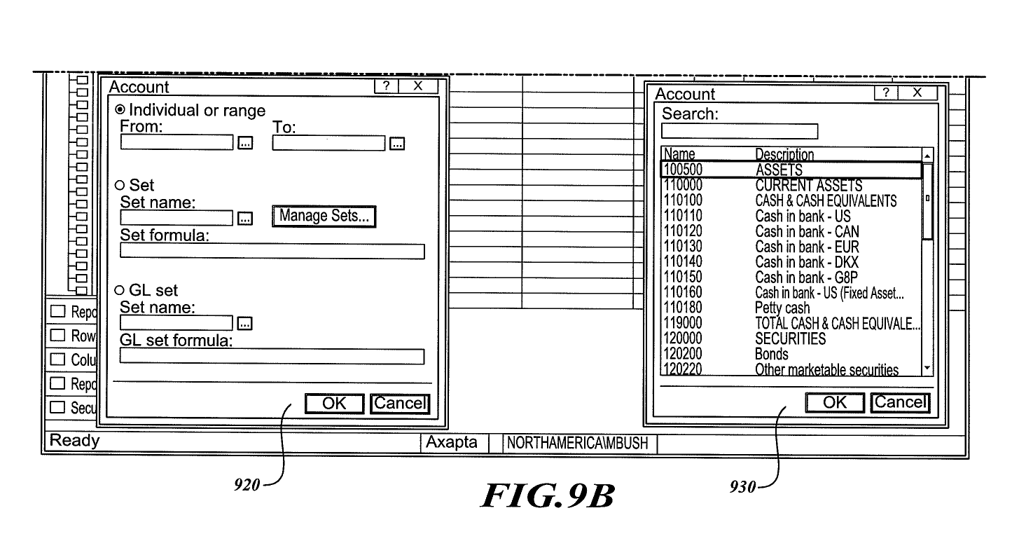

FIG. 9 shows using the interface to build a tree format to refine the report definition. The optional tree format provides more granularity to the report definition. A reporting tree creates a hierarchical picture of the organization. In the tree format, each leaf node can include any individual or range of dimension members as defined by the user. After indicating real time dimension access by selecting box 905 under the account mask column, window 910 is displayed. Window 910 lists the dimensions that are available. The user then selects which dimension they want to use. Using window 920, if the user chooses an individual or range, a list of dimension members is displayed to the user to pick from in window 930. As described above, when the user selects a set, then a list of available sets is displayed to the user within window 930.

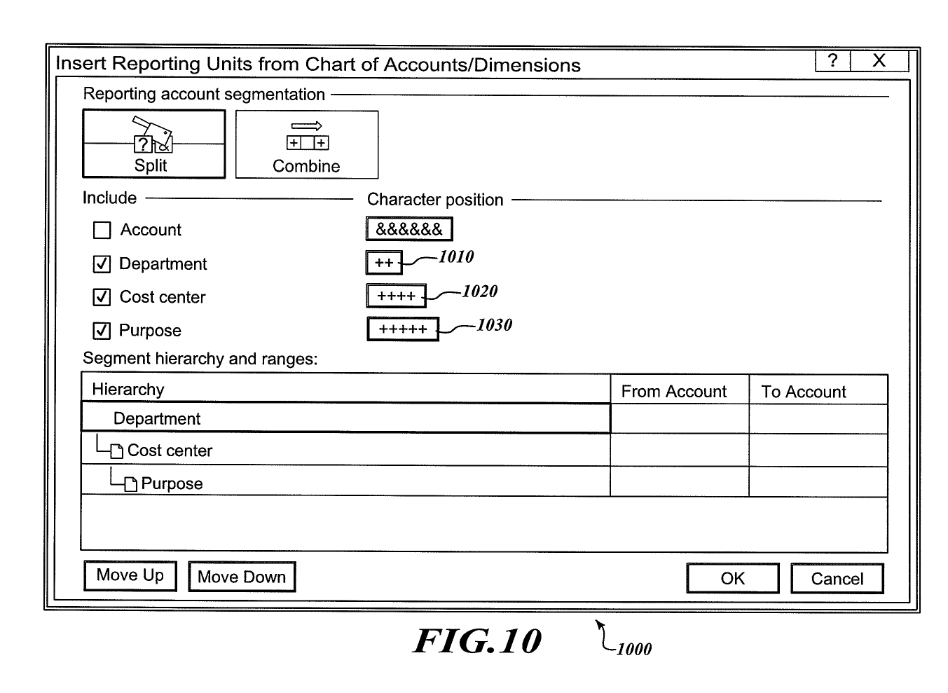

FIG. 10 illustrates inserting reporting units from chart of accounts/dimensions. Using screen 1000, the user can define a dimension or a combination of dimensions to be used to automatically build a tree definition. As with the other definitions, a fully qualified account is not needed. Ampersands “&” are used to ignore one or more of the dimensions and the plus signs “+” are used to include/build the dimensions. In screen 1000, the user has selected to build a tree including the department 1010, cost center 1020, and purpose 1030 dimensions within the tree. As can be seen, the hierarchy is department with cost center as a child and purpose as a child of the cost center.

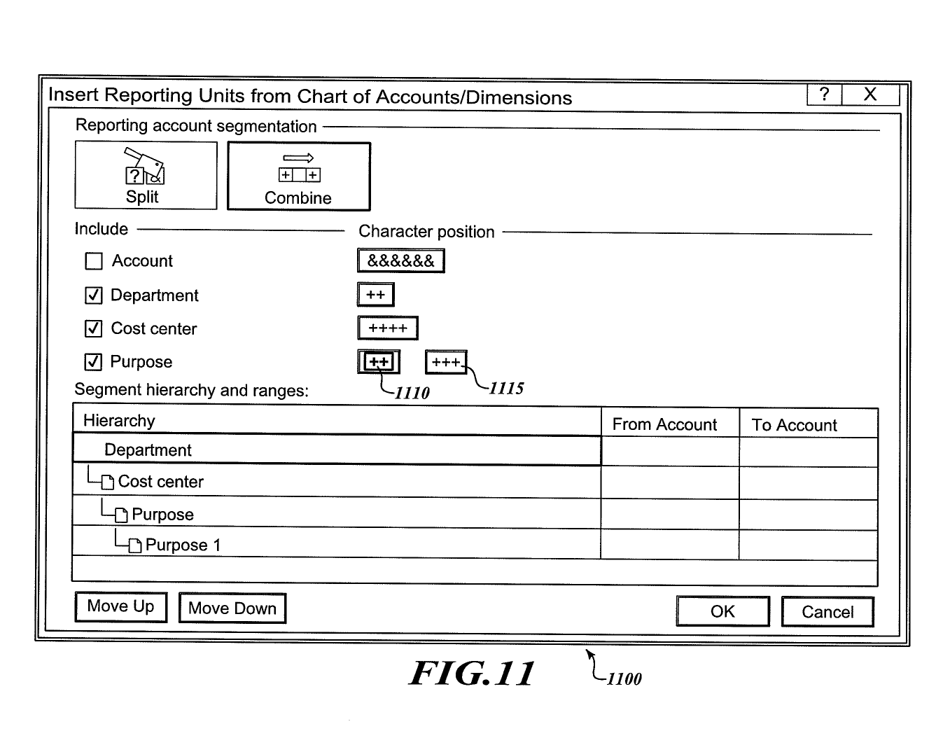

FIG. 11 shows dynamically splitting segments. Screen 1100 shows splitting the purpose dimension within the tree. As illustrated, the purpose dimension has been split into two segments (segment 1110 and segment 1115). Referring to the hierarchy, purpose 1 is the newly split purpose (segment 1115) within the hierarchy.

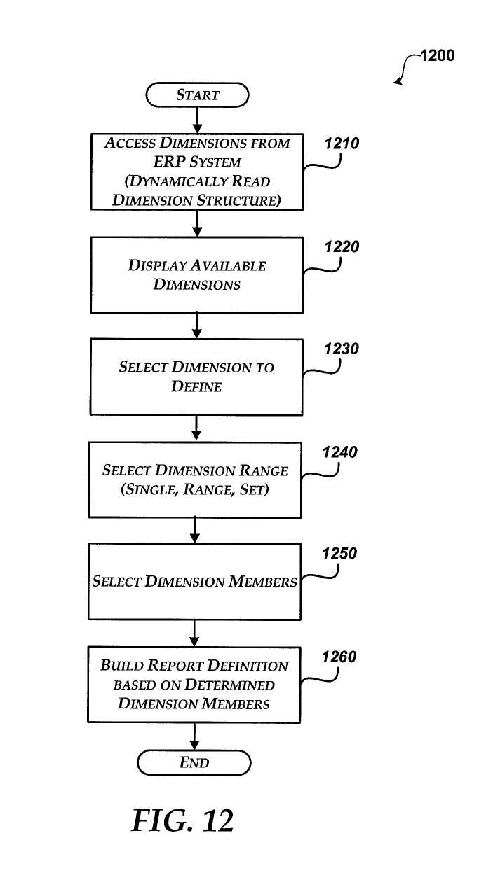

Referring now to FIG. 12, an illustrative process 1200 for defining a report definition for a ERP system is provided.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 1210, where the available dimensions within an ERP system are accessed. According to one embodiment, the dimensions are accessed in real time from the ERP system. The available dimensions depend on the ERP system being accessed.

Flowing to operation 1220, the available dimensions are displayed to the user.

Moving to operation 1230, a dimension is selected from the available dimensions to define a report. According to one embodiment, a selection is received from a user through a user interface (See FIGS. 3-11 and related discussion for exemplary user interface screens) to determine the dimension to define a report.

Moving to operation 1240, the dimension range is selected by determining whether a single dimension member is to be used, a range of dimension members is to be used or a set of dimension members is to be used.

Transitioning to operation 1250, the dimension members are selected. The dimension members may be manually selected by a user through a displayed list of the dimension members that correspond to the selection at operation 1240. If a single dimension member or a range of dimension members is selected then a list of single dimension members are displayed to the user. If a set of dimension members is selected then sets of dimension members are displayed. The dimension members may also be automatically selected by receiving filter criteria through the user interface that indicates what dimension members to include.

Moving to operation 1260, the report definition is built based on the selections and the determined dimension members. This process may be repeated any number of times should more dimensions be desired to be defined within the report.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for creating a report definition for a dimension based ERP (“Enterprise Resource Planning”) system, comprising:
retrieving available dimensions from the dimension based ERP system;
displaying the available dimensions;
selecting at least one of the available dimensions;
determining dimension members relating to the selected dimension that are to be defined within the report;
creating the report definition; wherein creating the report definition includes specifying the determined dimension members within the report definition without referencing the dimensions that are not included within the report; and
storing the report definition.

2. The method of claim 1, wherein retrieving the available dimensions from the dimension based ERP system comprises importing dimension hierarchies directly from the ERP system.

3. The method of claim 1, further comprising selecting a dimension range by determining whether a single dimension member is to be selected, a range of dimension members is to be selected or a set of dimension members is to be selected.

4. The method of claim 1, further comprising displaying dimension members relating to the selected dimension to be used; and wherein determining the dimension members comprises manually selecting the dimension members.

5. The method of claim 3, wherein determining the dimension members comprises automatically selecting the dimension members.

6. The method of claim 5, wherein automatically determining the dimension members comprises using filter criteria.

7. The method of claim 1, wherein the filter criteria include a first character that indicates to include a dimension and a second character that indicates to exclude a dimension.

8. The method of claim 1, further comprising creating a reporting tree definition that provides a hierarchy for the dimensions.

9. The method of claim 1, further comprising splitting a dimension to be included within the report definition.

10. The method of claim 1, wherein creating the report definition includes using a row definition and a column definition.

11. A computer-readable medium having computer-executable instructions for creating a report definition for a dimension based ERP (“Enterprise Resource Planning”) system, comprising:
retrieving available dimensions directly from the dimension based ERP system;
displaying the available dimensions within a user interface;
specifying one or more of the available dimensions to be used within the report;
determining dimension members that are associated with the one or more of the available dimensions to be used within the report;
creating a report definition using the determined dimension members by specifying only the determined dimensions within the report definition; and
storing the report definition.

12. The computer-readable medium of claim 11, further comprising displaying dimension members relating to the selected dimension to be used; defining a dimension range by determining whether a single dimension member is to be selected or a range of dimension members is to be selected or a set of dimension members is to be selected; and wherein determining the dimensions comprises manually selecting the dimensions.

13. The computer-readable medium of claim 11, wherein determining the dimensions comprises automatically determining the dimensions by using filter criteria to automatically select the dimensions.

14. The computer-readable medium of claim 11, wherein creating the report definition includes using a row definition, a column definition and a reporting tree definition.

15. The computer-readable medium of claim 14, wherein the reporting tree definition provides a hierarchy for the determined dimensions.

16. A system for creating a report definition, comprising:
a dimension based ERP (“Enterprise Resource Planning”) system;
a processor and a computer-readable medium;
an operating environment stored on the computer-readable medium and executing on the processor; and
a reporting tool operating under the control of the operating environment and operative to:
retrieve available dimensions directly from the dimension based ERP system;
display the available dimensions on a user interface;
receive a selection from the user interface relating to one or more of the available dimensions to be used within the report definition;
determine dimension members relating to the selection to be used within the report;
creating the report definition; wherein creating the report definition includes specifying only the determined dimensions within the report definition; and
store the report definition.

17. The system of claim 16, further comprising selecting a dimension range by receiving a selection through the user interface that indicates whether a single dimension member is to be selected, a range of dimension members is to be selected or a set of dimension members is to be selected.

18. The system of claim 16, further comprising displaying dimension members relating to the selected dimension to be used; and wherein determining the dimension members comprises manually selecting the dimension members.

19. The system of claim 16, wherein selecting the dimensions comprises automatically selecting the dimensions by receiving filter criteria through the user interface.

20. The method of claim 16, further comprising utilizing a row definition, a column definition and a reporting tree definition.
